(19) United States
(12) Patent Application Publication
(10) Pub. No.: US 2025/0029234 A1
(43) Pub. Date: Jan. 23, 2025

(54) TAPE AND REEL MACHINE VISION SYSTEMS

(71) Applicant: SKYWORKS SOLUTIONS, INC., Irvine, CA (US)

(72) Inventor: Daniel MURILLO GONZALEZ, Mexicali (MX)

(21) Appl. No.: 18/776,000

(22) Filed: Jul. 17, 2024

Related U.S. Application Data
(60) Provisional application No. 63/528,270, filed on Jul. 21, 2023.

(51) Int. Cl. G06T 7/00

(52) U.S. Cl. CPC G06T 7/001; G06T 7/0008; G06T 2207/20081

(57) ABSTRACT

A tape and reel machine vision inspection system may include: a camera; a lens; one or more lights; a printed circuit board interface configured to interface the tape and reel machine vision inspection system with a tape and reel machine configured to process a plurality of components in a packaging process; a frame grabber; and a computing device including a processor configured to: determine one or more templates for inspecting the plurality of components processed by the tape and reel machine; obtain at least one image of a component processed by the tape and reel machine using the camera and the lens; compare the image of the component processed by the tape and reel machine with the one or more templates to determine whether the image of the component and the one or more templates match within a specified threshold; and determine whether the component passes or fails inspection.

### CROSS-REFERENCE TO RELATED APPLICATION(S)

This application claims the benefit of U.S. Provisional Application No. 63/528,270, filed Jul. 21, 2023, entitled “TAPE AND REEL MACHINE VISION SYSTEM,” which is incorporated herein by reference in its entirety.

### BACKGROUND

### Field

The present disclosure generally relates to systems and methods for inspecting and detecting potentially defective components and/or modules.

### Description of the Related Art

In semiconductor manufacturing, an automated tape and reel process can follow electrical testing of electronic components. Machines that perform the tape and reel process can pick and place components for packaging and sending to customers. After the tape and reel process ends, the components can be sent to customers. To ensure quality of the components, each roll can be inspected to avoid defects, for example, by operators.

### SUMMARY

According to some implementations, the present disclosure relates to a tape and reel machine vision inspection system. The tape and reel machine vision inspection system can include a camera, a lens, one or more lights, a printed circuit board (PCB) interface configured to interface the tape and reel machine vision inspection system with a tape and reel machine configured to process a plurality of components in a packaging process, a frame grabber, and a computing device including a processor. The processor can be configured to determine one or more templates for inspecting the plurality of components processed by the tape and reel machine, obtain at least one image of a component that is processed by the tape and reel machine using the camera and the lens, compare the image of the component that is processed by the tape and reel machine with the one or more templates to determine whether the image of the component and the one or more templates match within a specified threshold, and determine whether the component passes or fails inspection.

In some examples, the tape and reel machine vision inspection system can be configured to adjust one or more of: a light intensity, contrast control, gamma control, or focus of the lens. In certain examples, the one or more lights can include a light-emitting diode (LED). In some examples, the PCB interface can include one or more optocouplers for signal conditioning between the tape and reel machine and the tape and reel machine vision inspection system. In certain examples, the frame grabber can be configured to obtain one or more images of a component.

In certain examples, the processor can be further configured to generate a template from an image of a component obtained by the camera and the lens, wherein the template includes one or more regions of interest. For instance, the template can include one or more of: a part number, a lot number, or a reference pin.

In some examples, the processor can be further configured to determine and use multiple templates for inspecting components. In certain examples, the processor can be further configured to determine a first template using a main training option and determine a second template using an auxiliary training option. For instance, the processor can be further configured to inspect the component based on the first template, and inspect the component based on the second template in response to determining that the component fails inspection based on the first template.

In certain examples, the determining whether the image of the component and the one or more templates match within a specified threshold can include determining whether the image of the component matches one or more regions of interest in the one or more templates by the specified threshold. In some examples, the processor can be further configured to synchronize a counter of the tape and reel machine and a counter of the tape and reel machine vision inspection system. In some examples, the processor can be further configured to detect an empty cavity in a roll. In certain examples, the processor can be further configured to provide in a user interface one or more of: a number of components that passed, a number of components that failed, a total number of components, a counter of the tape and reel machine, a counter of the tape and reel machine vision inspection system, or an indicator of inspection result. In some examples, the processor can be further configured to identify a defect selected from one or more of: an incorrect part, an incorrect lot, an incomplete component, an empty cavity, a misoriented placement, or a poor quality marking.

According to some implementations, the present disclosure relates to a method of performing an automated tape and reel machine vision inspection. The method can include determining, by a computing device of a tape and reel machine vision inspection system, one or more templates for inspecting a plurality of components processed by a tape and reel machine in a packaging process, the tape and reel machine vision inspection system including a camera, a lens, one or more lights, a printed circuit board (PCB) interface configured to interface the tape and reel machine vision inspection system with the tape and reel machine, and a frame grabber. The method can also include obtaining, by the computing device, at least one image of a component that is processed by the tape and reel machine using the camera and the lens. The method can further include comparing, by the computing device, the image of the component that is processed by the tape and reel machine with the one or more templates to determine whether the image of the component and the one or more templates match within a specified threshold. The method can additionally include determining, by the computing device, whether the component passes or fails inspection.

In some examples, the method can further include adjusting one or more of: a light intensity, contrast control, gamma control, or focus of the lens. In certain examples, the one or more lights can include a light-emitting diode (LED). In some examples, the PCB interface can include one or more optocouplers for signal conditioning between the tape and reel machine and the tape and reel machine vision inspection system. In certain examples, the frame grabber can be configured to obtain one or more images of a component.

In certain examples, the method can also include generating a template from an image of a component obtained by the camera and the lens, wherein the template includes one or more regions of interest. For instance, the template can include one or more of: a part number, a lot number, or a reference pin.

In some examples, the method can additionally include determining and using multiple templates for inspecting components. In certain examples, the method can also include determining a first template using a main training option, and determining a second template using an auxiliary training option. For instance, the method can further include inspecting the component based on the first template, and inspecting the component based on the second template in response to determining that the component fails inspection based on the first template.

In certain examples, the determining whether the image of the component and the one or more templates match within a specified threshold can include determining whether the image of the component matches one or more regions of interest in the one or more templates by the specified threshold. In some examples, the method can further include synchronizing a counter of the tape and reel machine and a counter of the tape and reel machine vision inspection system. In some examples, the method can additionally include detecting an empty cavity in a roll. In certain examples, the method of can also include providing in a user interface one or more of: a number of components that passed, a number of components that failed, a total number of components, a counter of the tape and reel machine, a counter of the tape and reel machine vision inspection system, or an indicator of inspection result. In some examples, the method can further include identifying a defect selected from one or more of: an incorrect part, an incorrect lot, an incomplete component, an empty cavity, a misoriented placement, or a poor quality marking.

### DESCRIPTION

The headings provided herein, if any, are for convenience only and do not necessarily affect the scope or meaning of the claimed invention.

In semiconductor manufacturing, an automated tape and reel process can follow electrical testing of electronic components. Machines that perform the tape and reel process can pick and place components for packaging and sending to customers. For example, a tape and reel machine may pick and place a thousand micro components per hour at high precision level. After the tape and reel process ends, the components can be sent to customers. To ensure quality of the components, each roll can be inspected to avoid defects and prevent line stops with the customers. For instance, defects may refer to defects or issues in connection with the tape and reel process. Examples of defects may include empty cavities, poor quality markings, incomplete parts, misoriented placement, etc. In some cases, inspection of components in each roll may be performed visually by operators for marking quality and correct placement, for example, using a high magnification microscope. However, visual inspection by operators can result in human errors as well as long completion times for inspection. Accordingly, an inspection system can be provided to inspect components packaged by a tape and reel machine based on requirements of the tape and reel machine. For example, the inspection system can utilize machine vision to perform high speed, high capacity inspection of components in the tape and reel process in order to detect defects and reject or accept components.

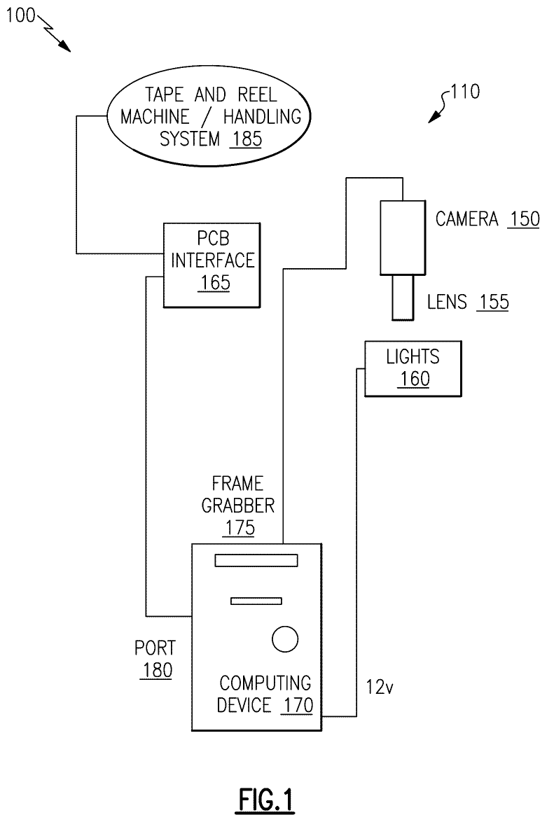

FIG. 1 is a block diagram 100 of a tape and reel machine vision system 110, according to some embodiments of the present disclosure. In some embodiments, the machine vision system (MVS) 110 can include a camera 150, a lens 155, one or more lights 160, a printed circuit board (PCB) interface 165 for coupling signals, a computing device 170 or a personal computer (PC) for implementing the machine vision system 110, a frame grabber 175, and a port 180. The camera 150 and the lens 155 can capture image or video data of components that are being placed in a roll. The lights 160 can provide lighting for capturing image or video data of components that are being placed in a roll. As an example, the lights 160 can be light-emitting diodes (LEDs). In some cases, voltage for the lights 160 may be provided by the computing device 170 (e.g., 12 volts (V)). The lights 160 may provide a specified amount of light into the camera 150 and/or the lens 155. The PCB interface 165 can couple signals, for example, between the computing device 170 and a tape and reel machine or handler 185. The computing device 170 can be configured to implement various functionalities associated with the MVS 110. The computing device 170 can run an application associated with the MVS 110. The frame grabber 175 can capture or grab individual digital still frames from an analog video signal or a digital video stream. The port 180 can connect the computing device 170 and the PCB interface 165. As an example, the port 180 can be a parallel port (e.g., an LPT1 port). The MVS 110 can interface or be integrated with a tape and reel machine or handler 185. The tape and reel machine or handler 185 can pick and place components in cavities of a roll and seal the components for delivery to customers. Examples of tape and reel machine/handlers can include Microvision, Epson NS, etc. In some embodiments, the tape and reel machine/handler 185 can be a gravity tape and reel machine/handler. Many variations are possible.

The MVS 110 can be used to inspect any component that can be packaged in a roll, for example, by a tape and reel machine 185. Examples of components can include various electronic modules, including single-sided modules, dual-sided modules, etc. Modules can include radio-frequency (RF) modules. A module can include various types of parts or components, including power amplifiers, low noise amplifiers, switches, etc. The MVS 110 may inspect components based on requirements of the tape and reel machine 185. Examples of requirements may include types of defects, number of empty cavities per roll, number of continuous empty cavities, misplacement, misorientation, marking quality, incomplete parts, etc.

In some embodiments, the MVS 110 can include a processer, a PCB with one or more optocouplers for signal conditioning with a tape and reel machine, a frame grabber, a camera, a lens, a light-emitting diode (LED) set, etc. As an example, a MVS 110 can interface with a Microvision handler system, and the MVS 110 can include a PC Pentium III 500 Megahertz (MHz) dual-processor, a PCB with optocouplers for signal conditioning with a Microvision handler, Frame grabber PXR 800 Imagenation, STC-11001B Sentech camera, 23FM50L Tamron lens, and an orange color LED set. As another example, a MVS 110 can interface with an Epson NS handler system, and the MVS 110 can include a PC Pentium IV 1 Gigahertz (GHz) dual-processor, a PCB with optocouplers for signal conditioning with an Epson NS handler, Frame grabber PXR 800 Imagenation, STC-11001B Sentech camera, ZOOM 7000 Navitar lens, and an orange color LED set. The above examples are provided for illustrative purposes, and the MVS 110 can interface with different tape and reel machines and can include any components as appropriate. Various types of components can be used for the MVS 110, such as different types of processors, cameras, lenses, lights, PCBs, frame grabbers, etc.

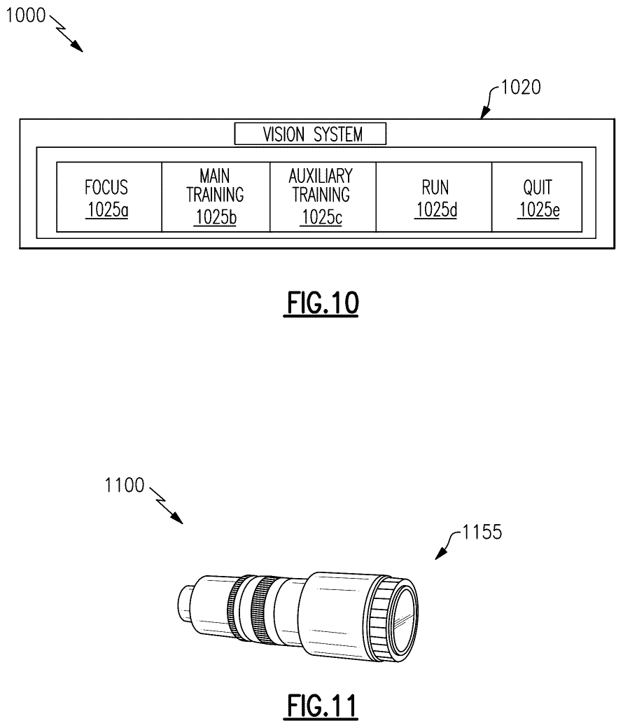

A MVS 110 can be configured to perform inspection in various ways. A MVS 110 can be configured to interface with various tape and reel machine systems. A first example implementation of a MVS 110 is described in connection with FIGS. 2-9. For instance, the MVS 110 can interface with a Microvision tape and reel system. In the first example implementation, a template image can be selected, and components can be compared to the template image in order to determine whether a component is defective or not. A second example implementation of a MVS 110 is described in connection with FIGS. 10-15. For instance, the MVS 110 can interface with an Epson NS tape and reel system. In the second example implementation, two images can be used as template images such that the component can be compared to a second template image to determine whether the component is defective, in addition to an inspection based on a first template image. For example, if the component is determined to be defective based on a first template image, the component can be retested based on the second template image to confirm. According to certain aspects, determining whether a component is defective or not can refer to determining whether a component passes inspection or not. Any number of template images may be used to inspect components as appropriate.

In some embodiments, the MVS 110 can be developed using various platforms, software, etc., which may include Labview, Vision Assistant, etc. The MVS 110 can include a parallel port data acquisition board for communication with the tape and reel machine handler functions. Examples of handler functions can include fail detection, empty cavity, no conformity roll, system on process, vision system activated, etc. The MVS 110 can provide an interactive user interface and display relevant menus, menu items or options, information, etc. Details relating to the MVS 110 are further explained below in connection with FIGS. 2-16. In some embodiments, similar names and/or reference numbers in figures can refer to the same or similar components.

FIG. 2 is a diagram 200 of a main menu 220 of options to operate a tape and reel machine vision system, according to some embodiments of the present disclosure. For example, the main menu 220 can be a menu of an application associated with the machine vision system. The machine vision system can be the machine vision system 110 of FIG. 1. The application may also be referred to as the MVS application. The main menu 220 can include one or more menu items 225. In the example of FIG. 2, the main menu 220 includes a focus option 225a, a training option 225b, a run option 225c, a non-conforming roll option 225d, and a quit option 225e. The focus option 225a can adjust the lens and light intensity or brightness to obtain a desired image quality. The training option 225b can determine a template image for inspection. The training option 225b can define a space and area within an image to inspect, for example, with reference to a component. The run option 225c can execute inspection based on one or more templates. The non-conforming roll option 225d can allow a roll to be unpacked, for example, when a defect cannot be corrected by a user. The quit option 225e can exit the application. According to certain aspects, a user may sequentially select the focus option 225a, the training option 225b, and the run option 225c in order to operate the MVS and perform inspection.

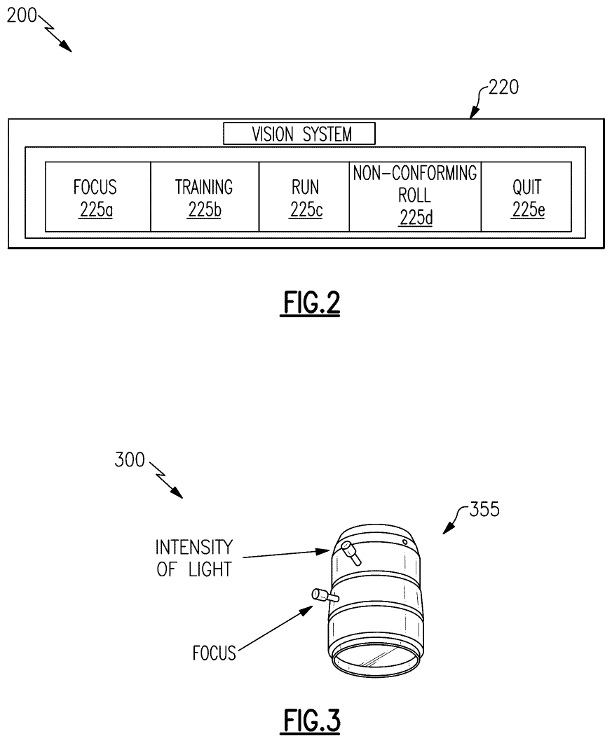

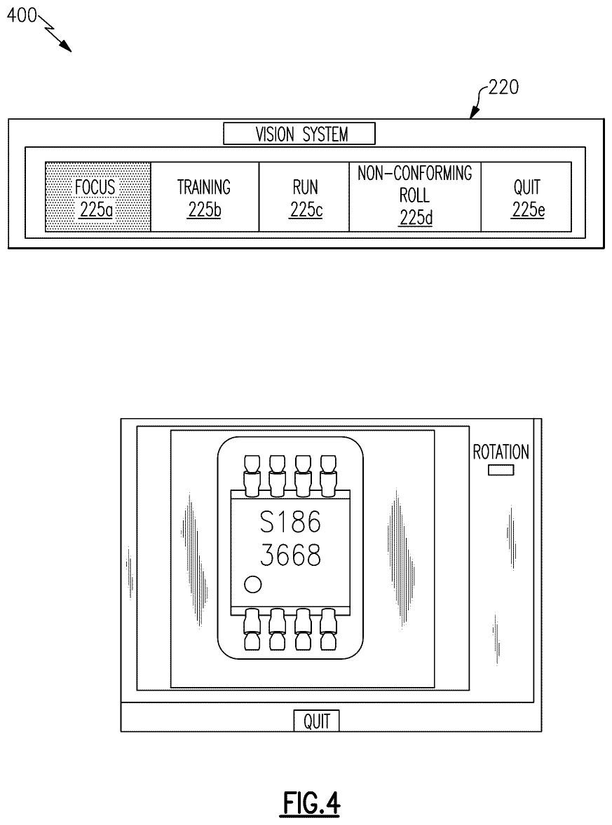

FIG. 3 is a diagram 300 that shows a type of lens 355 that can be used with a tape and reel machine vision system, according to some embodiments of the present disclosure. The lens 355 can be used with a camera to inspect components. Any suitable lens and/or camera may be used for the tape and reel machine vision system. Light intensity and/or focus of the lens 355 may be adjusted as appropriate in order to capture image or video data of components. For example, the light intensity and/or focus of the lens 355 may be adjusted to capture image or video data that meets a desired quality.

FIG. 4 is a diagram 400 showing a focus option of a tape and reel machine vision system, according to some embodiments of the present disclosure. For example, the focus option can be the focus option 225a of the main menu 220 in FIG. 2. The focus option can enable finding optimal parameters of light intensity and focus on a component and better magnification for resolution of image data capture. For instance, the focus option can involve manipulation of the lens or the height of the camera. The camera and/or the lens may also be rotated, for example, by a specified number of degrees.

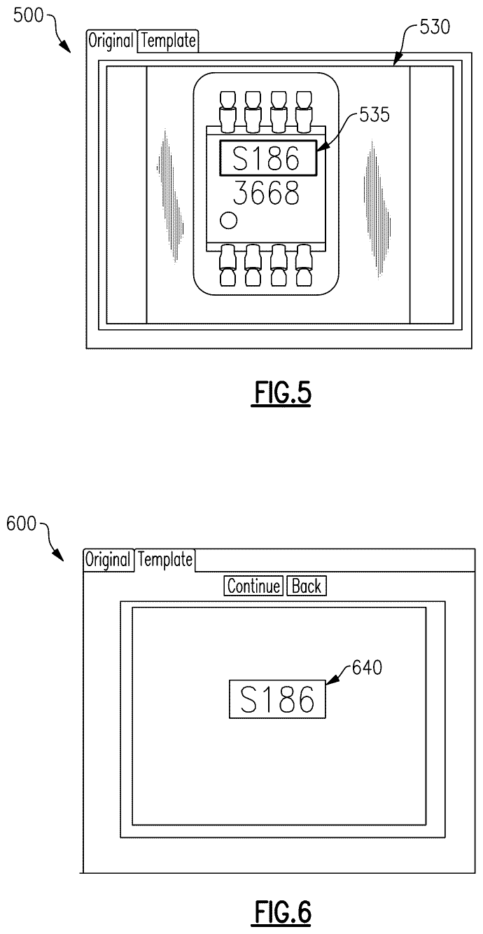

FIG. 5 is a diagram 500 showing a training option of a tape and reel machine vision system, according to some embodiments of the present disclosure. For example, the training option can be the training option 225b of the main menu 220 in FIG. 2. In the training option, the MVS 110 can be trained to select a target image 530 that can be used as a reference for the MVS 110. The target image 530 can be used to create a template for inspection. The target image 530 can be an image of a component captured by a camera and a lens of the MVS. The image 530 of the component may show a top marking, a part number, a lot number, etc. associated with the component. The image 530 of the component can also show a reference pin or hole that can indicate the orientation of the component. For instance, the reference pin may be a white circle or have another appropriate shape or color. The orientation of the component may be determined based on the location of the reference pin.

After the target image 530 is selected, a user can define a region of interest 535 within the image to be used as a template for inspection. For example, the user can define a region of interest 535 to include the part number of the component. The user may define one or more regions of interest 535 within the target image 530. A region of interest 535 may include different portions of a component, such as a marking or a portion thereof, a reference pin, etc. For instance, a region of interest 535 can include a part number, a lot number, etc. In some cases, characters or numbers that can look valid in different orientations (e.g., 0, 8, etc.) may be avoided in the training option for creating a template. All characters or a subset of characters in a marking may be included in a template, depending on the embodiment. Two or more characters may be included in a template. Characters may include alphanumeric characters, symbols, etc.

FIG. 6 is a diagram 600 showing a training option of a tape and reel machine vision system, according to some embodiments of the present disclosure. For example, the training option can be the training option 225b of the main menu 220 in FIG. 2. As explained above in connection with FIG. 5, a target image to use as a reference for inspection can be selected, and a user can define one or more regions of interest within the target image to create a template 640. After the user is done with creating a template 640, the user can select continue or go back to select different images or make changes to the template 640.

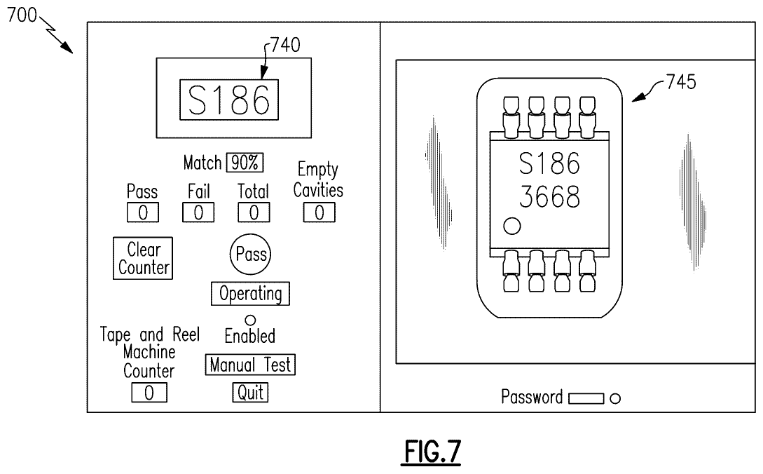

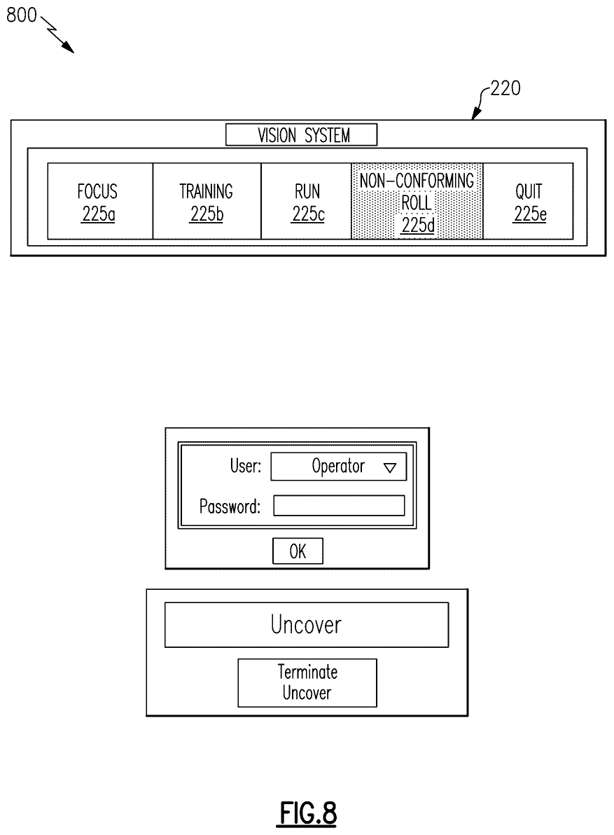

FIG. 7 is a diagram 700 showing a run option of a tape and reel machine vision system, according to some embodiments of the present disclosure. For example, the run option can be the run option 225c of the main menu 220 in FIG. 2. An image 745 of a component that is currently being inspected can be obtained by a camera and lens of the machine vision system. The image 745 of the component can be compared to a template 740. For instance, the template 740 can be similar to the template 640 in FIG. 6. As an example, the part number of the component in the image 745 can be compared to the part number in the template 740. The MVS can determine whether the image 745 matches the template 740 within a specified threshold or percentage. In some cases, the specified threshold or percentage may be referred to as a level of acceptance. As an example, the MVS can set the match percentage to 90%. Any appropriate number or percentage may be specified by a user. For instance, the number or percentage may be changed by the user by entering a username and/or password. A default number or percentage may be set, which can be used each time the MVS application starts.

The screen for the run option can display relevant information for inspection of components. Such information may include one or more of: a number of components that passed, a number of components that failed, a total number of components and/or samples, a number of empty cavities, a tape and reel machine counter, an indicator of result from each evaluation, statistical information, etc. A user can make sure the tape and reel machine is running when the run option is selected to avoid problems with counters. A counter of the MVS for components can be synchronized with the counter of the tape and reel machine in order to maintain an accurate count of components that are being inspected. The user can check that the tape and reel machine counter is operating to make sure that the MVS counter and the tape and reel machine counter are synchronized. The run option can also provide an option to clear the counter of the MVS. The run option can show the test result for each component (e.g., pass/fail). For example, a green indicator can be displayed for a component that passes inspection, and a red indicator can be displayed for a component that fails inspection. The run option can also show the MVS application status (e.g., enabled, operating, etc.). In some embodiments, the run option may include an option for manual inspection.

The MVS can be configured to communicate with a tape and reel machine using one or more of following input signals: Startup Test and Output Signals, Test Results, Vision System Test Enabled, Process Test, etc. For example, the MVS can communicate with a tape and reel machine through a parallel port, used as a data acquisition card. In some embodiments, the tape and reel machine can be a Microvision handler. Examples of handler functions for communicating with the MVS can include one or more of: fail detection, empty cavity, no conformity roll, etc. In some embodiments, various application programming interfaces (APIs) and/or dynamic link library (DLLs) may be used to interface or communicate with various components of the MVS.

FIG. 8 is a diagram 800 showing a non-conforming roll option of a tape and reel machine vision system, according to some embodiments of the present disclosure. For example, the non-conforming roll option can be the non-conforming roll option 225d of the main menu 220 in FIG. 2. The non-conforming roll option can be selected when an inspection process should be stopped or removed. For instance, the inspection process can be stopped temporarily in order to address or fix defects. A user can enter the username and password in order to stop the inspection process. The user can select an uncover option to stop the inspection process. The user can select a terminate uncover option to return to the run option. The non-conforming roll option can allow a roll in the inspection process to be unpacked, for example, when a defect cannot be corrected by a user.

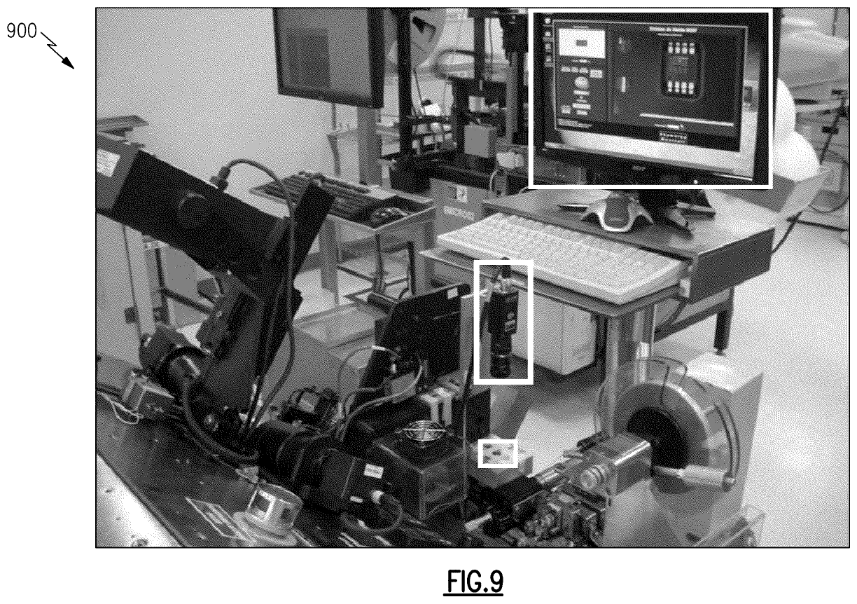

FIG. 9 is a diagram 900 showing a tape and reel machine vision system integrated with a tape and reel machine, according to some embodiments of the present disclosure. FIG. 9 shows components of the MVS, such as a camera, a lens, lights, and a computing device. A monitor can display the screen of an application associated with the MVS. The example of FIG. 9 is provided for illustrative purposes, and many variations are possible.

In some embodiments, the MVS can detect an empty cavity in a roll. For instance, the MVS can be configured to verify that there are no more than a specified number of empty cavities in one roll, no more than a specified number of continuous empty cavities, etc. The specified number of empty cavities in one roll and/or the specified number of continuous empty cavities can be set by a user as appropriate. As an example, the MVS can check whether there are no more than five (5) empty cavities in one roll, no more than one (1) continuous empty cavity, etc. The MVS may be trained based on one or more images of empty cavities, and in case of a failed component, the MVS can retest the component to verify whether the failure is due to positioning or an empty cavity. The MVS can stop the tape and reel machine until the error is corrected. The tape and reel machine and the MVS can continue after the error is corrected.

In this way, the tape and reel machine vision system can provide automated machine vision inspection using templates for inspecting components. By eliminating or reducing reliance on human visual inspection by operators, the MVS can increase accuracy and speed of inspection of components that are packaged in a tape and reel process. The MVS can be configured to operate in various manners and to interface with different tape and reel systems. According to certain aspects, a customized inspection workflow or process can be designed and implemented using various platforms, software, etc. The inspection workflow or process can be integrated into existing tape and reel systems or processes in a seamless manner and minimizing additional costs. The MVS can integrate packaging and inspection of components in a single process, which can provide savings in space and time as well as automation and standardization of procedures more flexible to components being produced and inspected. The MVS can assure quality of finished components and eliminate human visual inspection. In some embodiments, the MVS may provide an additional inspection before the sealing process for components by the tape and reel machine.

As mentioned above, FIGS. 10-15 show another example implementation of a tape and reel machine vision system, according to some embodiments of the present disclosure. For instance, the MVS can interface with an Epson NS tape and reel system. In this example implementation, two template images can be used to inspect the component for improved accuracy. For example, if the component is determined to be defective based on a first template image, the component can be retested based on the second template image to confirm.

In some embodiments, components of FIGS. 10-15 can be similar to components of FIGS. 1-9 having similar names and/or reference numbers. FIG. 10 is a diagram 1000 of a main menu 1020 of options to operate a tape and reel machine vision system, according to some embodiments of the present disclosure. For example, the main menu 1020 can be a menu of an application associated with the machine vision system. The machine vision system can be the machine vision system 110 of FIG. 1. The application may also be referred to as the MVS application. The main menu 1020 can include one or more menu items 1025. In the example of FIG. 10, the main menu 1020 includes a focus option 1025a, a main or primary training option 1025b, an auxiliary training option 1025c, a run option 1025d, and a quit option 1025e. The focus option 1025a can adjust the lens and light intensity, contrast control, and gamma control to obtain a desired image quality. The main training option 1025b can determine a first template image for inspection. The main training option 1025b can define a space and area within an image to inspect, for example, with reference to a component. The auxiliary training option 1025c can determine a second template image for inspection. The auxiliary training option 1025c can define a space and area within an image to inspect, for example, with reference to a component. The run option 1025d can execute inspection based on one or more templates. The quit option 1025e can exit the application. According to certain aspects, a user may sequentially select the focus option 1025a, the main training option 1025b, and/or the auxiliary training option 1025c, and the run option 1025d in order to operate the MVS and perform inspection.

FIG. 11 is a diagram 1100 that shows a type of lens 1155 that can be used with a tape and reel machine vision system, according to some embodiments of the present disclosure. The lens 1155 can be used with a camera to inspect components. Any suitable lens and/or camera may be used for the tape and reel machine vision system. Light intensity and/or focus of the lens 1155 may be adjusted as appropriate in order to capture image or video data of components. For example, the light intensity and/or focus of the lens 1155 may be adjusted to capture image or video data that meets a desired quality.

FIG. 12 is a diagram 1200 showing a focus option of a tape and reel machine vision system, according to some embodiments of the present disclosure. For example, the focus option can be the focus option 1025a of the main menu 1020 in FIG. 10. The focus option can enable finding optimal parameters of light intensity, contrast control, gamma control, and focus on a component and better magnification for resolution of image data capture. For instance, the focus option can involve manipulation of the lens or the height of the camera. The camera and/or the lens may also be rotated, for example, by a specified number of degrees. An example image 1230 of a component captured by the camera and the lens is shown in FIG. 12.

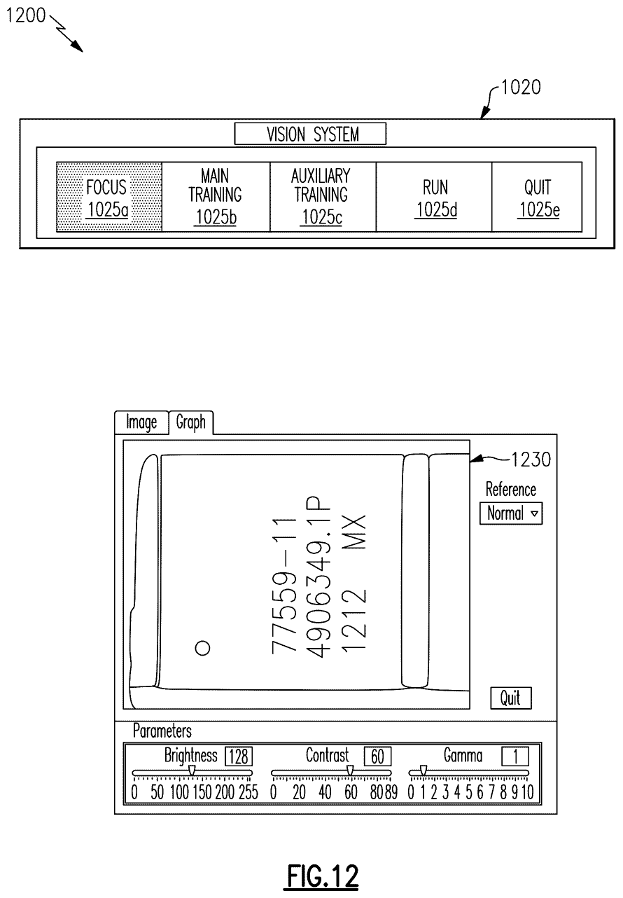

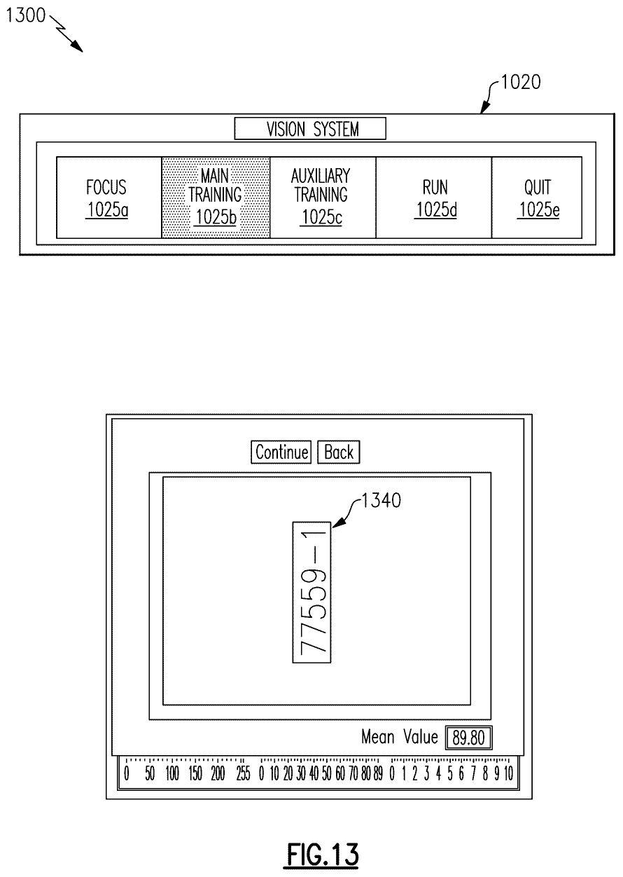

FIG. 13 is a diagram 1300 showing a main training option of a tape and reel machine vision system, according to some embodiments of the present disclosure. For example, the main training option can be the main training option 1025b of the main menu 1020 in FIG. 10. In the main training option, the MVS 110 can be trained to select a target image that can be used as a reference for the MVS 110. The target image can be used to create a template for inspection. The target image can be an image of a component captured by a camera and a lens of the MVS. For instance, the target image can be the same as or similar to the image 1230 in FIG. 12. The image of the component may show a top marking, a part number, a lot number, etc. associated with the component. The image of the component can also show a reference pin or hole that can indicate the orientation of the component. For instance, the reference pin may be a white circle or have another appropriate shape or color. The orientation of the component may be determined based on the location of the reference pin.

After the target image is selected, a user can define a region of interest within the image to be used as a template for inspection. For example, the user can define a region of interest to include the part number of the component and a region of interest to include the lot number of the component. The user may define one or more regions of interest within the target image. A region of interest may include different portions of a component, such as a marking or a portion thereof, a reference pin, etc. For instance, a region of interest can include a part number, a lot number, etc. In some cases, characters or numbers that can look valid in different orientations (e.g., 0, 8, etc.) may be avoided in the training option for creating a template. All characters or a subset of characters in a marking may be included in a template, depending on the embodiment. Two or more characters may be included in a template. Characters may include alphanumeric characters, symbols, etc.

As explained above, a target image to use as a reference for inspection can be selected, and a user can define one or more regions of interest within the target image to create a template 1340. After the user is done with creating a template 1340, the user can select continue or go back to select different images or make changes to the template 1340.

An auxiliary or secondary training option can be similar to the main training option. For example, the auxiliary training option can be the auxiliary training option 1025c of the main menu 1020 in FIG. 10. A user can select a target image to use as a reference for inspection and can define one or more regions of interest within the target image to create a template. Using the auxiliary training option, a user can create a second template that can be used to inspect a component. After the user is done with creating a second template, the user can select continue or go back to select different images or make changes to the second template. A second template to inspect a component can provide improved MTBA (mean time between assists) as well as ability to retest a failure result. The auxiliary training option can provide better performance on yield and retest.

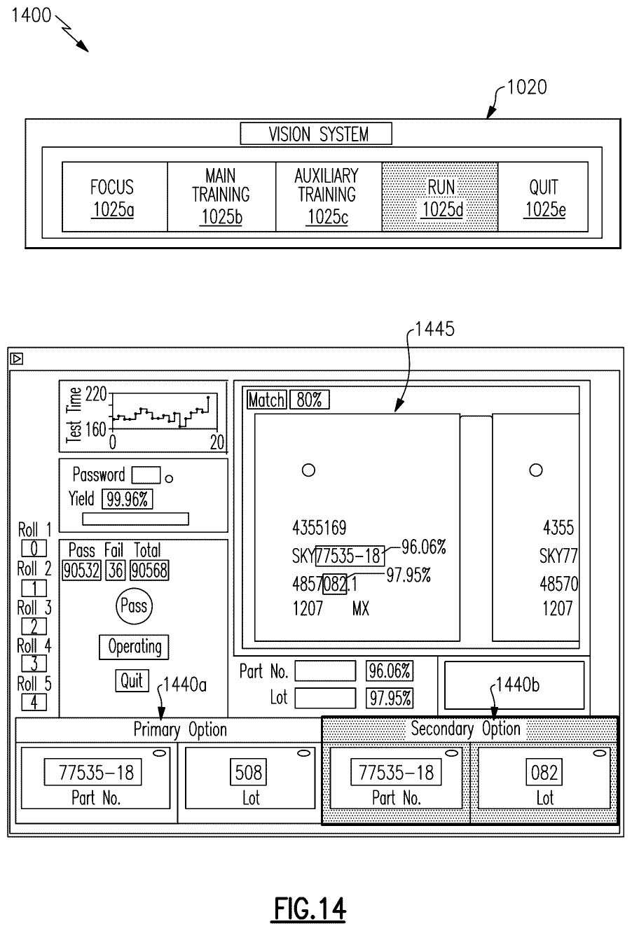

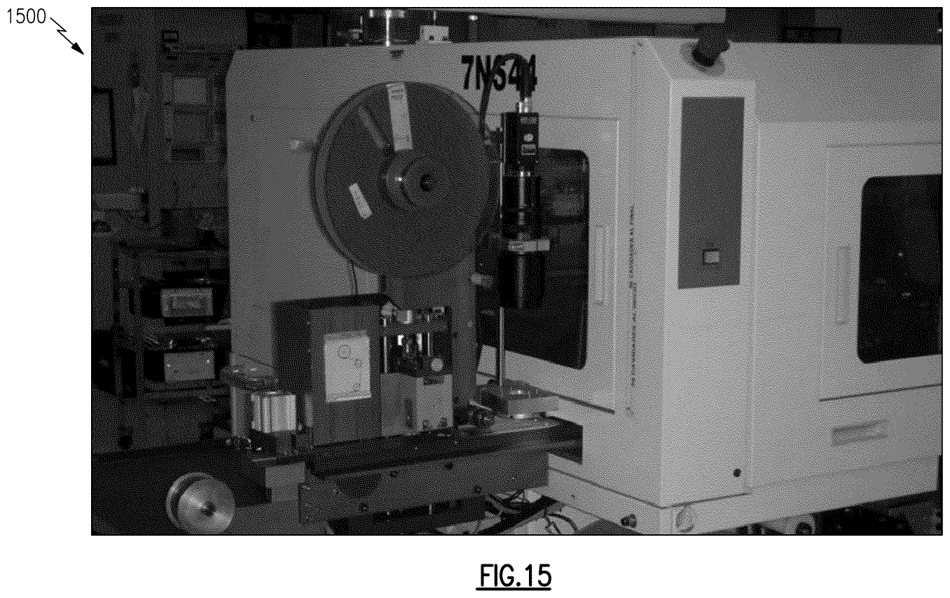

FIG. 14 is a diagram 1400 showing a run option of a tape and reel machine vision system, according to some embodiments of the present disclosure. For example, the run option can be the run option 1025d of the main menu 1020 in FIG. 10. An image 1445 of a component that is currently being inspected can be obtained by a camera and lens of the machine vision system. The image 1445 of the component can be compared to one or more templates 1440. For instance, the one or more templates 1440 can be similar to the template 1340 in FIG. 13. In the example of FIG. 14, two templates 1440a, 1440b are being used for inspection. The image 1445 of the component may be compared to one or both of the templates 1440a, 1440b. A template 1440 can have one or more regions of interest. For instance, the template 1440 can include a part number and a lot number. As an example, the part number of the component in the image 1445 can be compared to the part number in the template 1440a and/or the template 1440b. The lot number of the component in the image 1445 can be compared to the lot number in the template 1440a and/or the template 1440b. The MVS can determine whether the image 1445 matches the template 1440a and/or the template 1440b within a specified threshold or percentage. In some cases, the specified threshold or percentage may be referred to as a level of acceptance. As an example, the MVS can set the match percentage to 80%, 90%, etc. Any appropriate number or percentage may be specified by a user. For instance, the number or percentage may be changed by the user by entering a username and/or password. A default number or percentage may be set, which can be used each time the MVS application starts. The run option can check whether a portion of the image 1445 matches a region of interest in the template 1440 by the specified percentage. In the example of FIG. 14, the image 1445 is compared to the template 1440b, and the part number matches the part number in the template 1440b by 96.06%, and the lot number matches the lot number in the template 1440b by 97.95%.

The screen for the run option can display relevant information for inspection of components. Such information may include one or more of: a number of components that passed, a number of components that failed, a total number of components and/or samples, an indicator of result from each evaluation, statistical information, etc. The run option can show the test result for each component (e.g., pass/fail). For example, a green indicator can be displayed for a component that passes inspection, and a red indicator can be displayed for a component that fails inspection. The run option can also show the MVS application status (e.g., enabled, operating, etc.), yield, etc. In some embodiments, the run option may include an option for manual inspection.

The MVS can be configured to communicate with a tape and reel machine using one or more of following input signals: Startup Test and Output Signals, Test Results, Vision System Test Enabled, Process Test, etc. For example, the MVS can communicate with a tape and reel machine through a parallel port, used as a data acquisition card. In some embodiments, the tape and reel machine can be an Epson NS handler. Examples of handler functions for communicating with the MVS can include one or more of: fail detection, system in process, vision system activated, etc. In some embodiments, various APIs and/or DLLs may be used to interface or communicate with various components of the MVS.

FIG. 15 is a diagram 1500 showing a tape and reel machine vision system integrated with a tape and reel machine, according to some embodiments of the present disclosure. The MVS can include various components, such as a camera, a lens, lights, and a computing device. A monitor can display the screen of an application associated with the MVS. The example of FIG. 15 is provided for illustrative purposes, and many variations are possible.

In some embodiments, the MVS can retest a failed component with a second template. For instance, the MVS can help reduce stops due to image distortion or differences between laser marks on components or devices by previous training of a second template to use as a reference in case of a failure. The MVS can stop the tape and reel machine until the error is corrected. The tape and reel machine and the MVS can continue after the error is corrected.

As mentioned above, the tape and reel machine vision system can provide automated machine vision inspection using templates for inspecting components. The MVS can integrate packaging and inspection in a single process and provide flexibility, efficiency, and effectiveness in inspecting various components or devices.

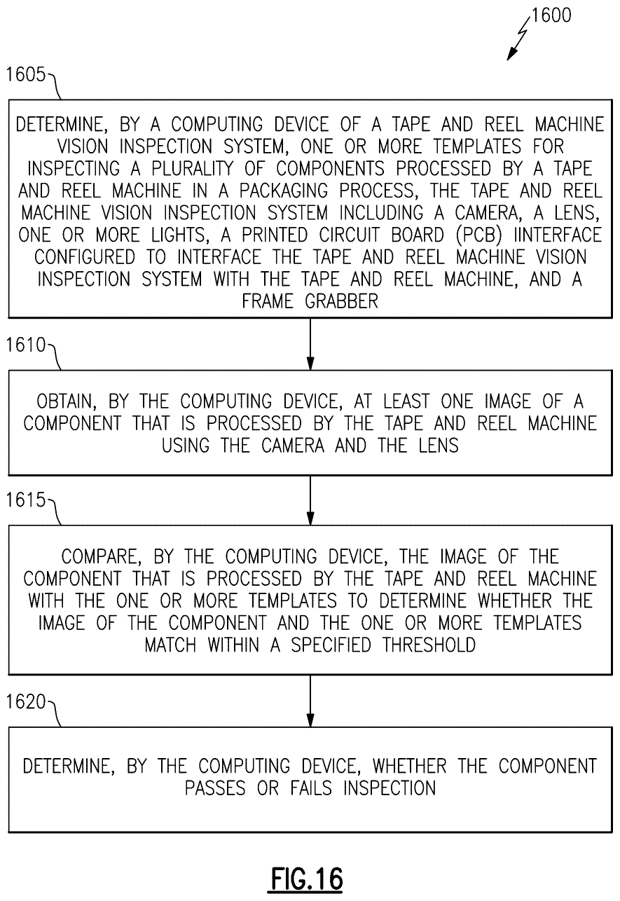

FIG. 16 shows a process 1600 that can be implemented to perform tape and reel machine vision inspection as described herein. For example, the process 1600 can be implemented by a tape and reel machine vision system. Certain details relating to the process 1600 are explained in more detail with respect to FIGS. 1-15. Depending on the embodiment, the process 1600 may include fewer or additional blocks, and the blocks may be performed in an order that is different from illustrated.

At block 1605, the process 1600 can determine, by a computing device of a tape and reel machine vision inspection system, one or more templates for inspecting a plurality of components processed by a tape and reel machine in a packaging process. The tape and reel machine vision inspection system can include a camera, a lens, one or more lights, a printed circuit board (PCB) interface configured to interface the tape and reel machine vision inspection system with the tape and reel machine, and a frame grabber. In some embodiments, the process 1600 can adjust one or more of: a light intensity, contrast control, gamma control, or focus of the lens. The one or more lights can include a light-emitting diode (LED). The frame grabber can be configured to obtain one or more images of a component. The PCB interface can include one or more optocouplers for signal conditioning between the tape and reel machine and the tape and reel machine vision inspection system.

At block 1610, the process 1600 can obtain at least one image of a component that is processed by the tape and reel machine using the camera and the lens.

At block 1615, the process 1600 can compare, by the computing device, the image of the component that is processed by the tape and reel machine with the one or more templates to determine whether the image of the component and the one or more templates match within a specified threshold. In certain embodiments, the process 1600 can generate a template from an image of a component obtained by the camera and the lens, wherein the template includes one or more regions of interest. The template can include one or more of: a part number, a lot number, or a reference pin. The process 1600 can determine and use multiple templates for inspecting components. The process 1600 may determine a first template using a main training option and determine a second template using an auxiliary training option. The process 1600 can inspect the component based on the first template and inspect the component based on the second template in response to determining that the component fails inspection based on the first template. The determining whether the image of the component and the one or more templates match within a specified threshold can include determining whether the image of the component matches one or more regions of interest in the one or more templates by the specified threshold.

At block 1620, the process 1600 can determine, by the computing device, whether the component passes or fails inspection. In some embodiments, the process 1600 can synchronize a counter of the tape and reel machine and a counter of the tape and reel machine vision inspection system. The process 1600 can detect an empty cavity in a roll. The process 1600 can provide in a user interface one or more of: a number of components that passed, a number of components that failed, a total number of components, a counter of the tape and reel machine, a counter of the tape and reel machine vision inspection system, or an indicator of inspection result. The process 1600 can identify a defect selected from one or more of: an incorrect part, an incorrect lot, an incomplete component, an empty cavity, a misoriented placement, or a poor quality marking.

A tape and reel machine vision system can be used to inspect various components, including packaged modules, such as dual-sided modules. Examples related to upper side and/or lower side configurations of packaged modules, as well as examples related to fabrication methods where a plurality of units can be fabricated in an array format, are described in U.S. Publication No. 2022/0319968, entitled “MODULE HAVING DUAL SIDE MOLD WITH METAL POSTS,” and U.S. Publication No. 2018/0096949, entitled “DUAL-SIDED RADIO-FREQUENCY PACKAGE WITH OVERMOLD STRUCTURE,” each of which is hereby expressly incorporated by reference in its entirety.

In some implementations, a device and/or a circuit having one or more features described herein can be included in an RF electronic device such as a wireless device. In some embodiments, such a wireless device can include, for example, a cellular phone, a smart-phone, a hand-held wireless device with or without phone functionality, a wireless tablet, etc.

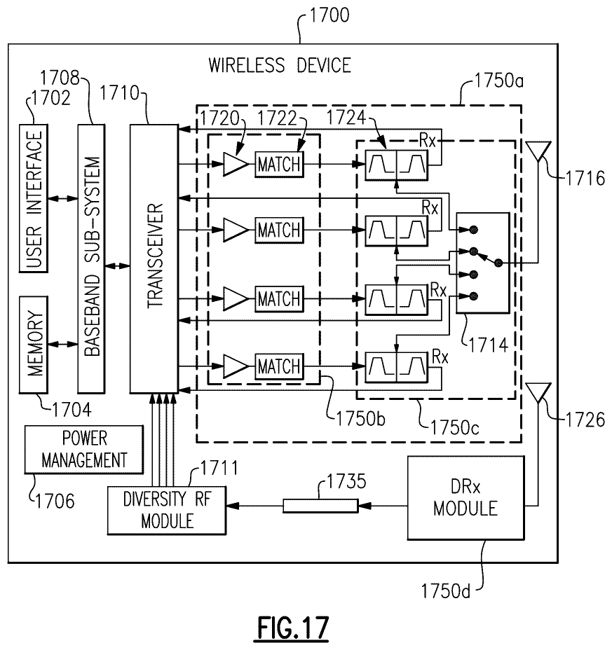

FIG. 17 depicts an example wireless device 1700 associated with one or more advantageous features described herein. Tape and reel machine vision inspection as described herein may be used to inspect one or more modules included in the wireless device 1700 or components thereof. In the example of FIG. 17, an RF module having one or more features as described herein can be implemented in a number of places. For example, an RF module may be implemented as a front-end module (FEM) indicated as 1750a. In another example, an RF module may be implemented as a power amplifier module (PAM) indicated as 1750b. In another example, an RF module may be implemented as an antenna switch module (ASM) indicated as 1750c. In another example, an RF module may be implemented as a diversity receive (DRx) module indicated as 1750d. It will be understood that an RF module having one or more features as described herein can be implemented with other combinations of components.

Referring to FIG. 17, power amplifiers (PAs) 1720 can receive their respective RF signals from a transceiver 1710 that can be configured and operated to generate RF signals to be amplified and transmitted, and to process received signals. The transceiver 1710 is shown to interact with a baseband sub-system 1708 that is configured to provide conversion between data and/or voice signals suitable for a user and RF signals suitable for the transceiver 1710. The transceiver 1710 can also be in communication with a power management component 1706 that is configured to manage power for the operation of the wireless device 1700.

The baseband sub-system 1708 is shown to be connected to a user interface 1702 to facilitate various input and output of voice and/or data provided to and received from the user. The baseband sub-system 1708 can also be connected to a memory 1704 that is configured to store data and/or instructions to facilitate the operation of the wireless device, and/or to provide storage of information for the user.

In the example wireless device 1700, outputs of the PAs 1720 are shown to be matched (via respective match circuits 1722) and routed to their respective duplexers 1724. Such amplified and filtered signals can be routed to a primary antenna 1716 through an antenna switch 1714 for transmission. In some embodiments, the duplexers 1724 can allow transmit and receive operations to be performed simultaneously using a common antenna (e.g., primary antenna 1716). In FIG. 17, received signals are shown to be routed to “Rx” paths that can include, for example, a low-noise amplifier (LNA).

In the example of FIG. 17, the wireless device 1700 also includes the diversity antenna 1726 and the shielded DRx module 1750d that receives signals from the diversity antenna 1726. The shielded DRx module 1750d processes the received signals and transmits the processed signals via a transmission line 1735 to a diversity RF module 1711 that further processes the signal before feeding the signal to the transceiver 1710.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A tape and reel machine vision inspection system comprising:
a camera;
a lens;
one or more lights;
a printed circuit board (PCB) interface configured to interface the tape and reel machine vision inspection system with a tape and reel machine configured to process a plurality of components in a packaging process;
a frame grabber; and
a computing device including a processor configured to:
determine one or more templates for inspecting the plurality of components processed by the tape and reel machine;
obtain at least one image of a component that is processed by the tape and reel machine using the camera and the lens;
compare the image of the component that is processed by the tape and reel machine with the one or more templates to determine whether the image of the component and the one or more templates match within a specified threshold; and
determine whether the component passes or fails inspection.

2. The tape and reel machine vision inspection system of claim 1 wherein the tape and reel machine vision inspection system is configured to adjust one or more of: a light intensity, contrast control, gamma control, or focus of the lens.

3. The tape and reel machine vision inspection system of claim 1 wherein the one or more lights include a light-emitting diode (LED).

4. The tape and reel machine vision inspection system of claim 1 wherein the PCB interface includes one or more optocouplers for signal conditioning between the tape and reel machine and the tape and reel machine vision inspection system.

5. The tape and reel machine vision inspection system of claim 1 wherein the processor is further configured to generate a template from an image of a component obtained by the camera and the lens, wherein the template includes one or more regions of interest.

6. The tape and reel machine vision inspection system of claim 5 wherein the template includes one or more of: a part number, a lot number, or a reference pin.

7. The tape and reel machine vision inspection system of claim 1 wherein the processor is further configured to determine and use multiple templates for inspecting components.

8. The tape and reel machine vision inspection system of claim 1 wherein the processor is further configured to:
determine a first template using a main training option; and
determine a second template using an auxiliary training option.

9. The tape and reel machine vision inspection system of claim 8 wherein the processor is further configured to:
inspect the component based on the first template; and
inspect the component based on the second template in response to determining that the component fails inspection based on the first template.

10. The tape and reel machine vision inspection system of claim 1 wherein the frame grabber is configured to obtain one or more images of a component.

11. The tape and reel machine vision inspection system of claim 1 wherein the determining whether the image of the component and the one or more templates match within a specified threshold includes determining whether the image of the component matches one or more regions of interest in the one or more templates by the specified threshold.

12. The tape and reel machine vision inspection system of claim 1 wherein the processor is further configured to synchronize a counter of the tape and reel machine and a counter of the tape and reel machine vision inspection system.

13. The tape and reel machine vision inspection system of claim 1 wherein the processor is further configured to detect an empty cavity in a roll.

14. The tape and reel machine vision inspection system of claim 1 wherein the processor is further configured to provide in a user interface one or more of: a number of components that passed, a number of components that failed, a total number of components, a counter of the tape and reel machine, a counter of the tape and reel machine vision inspection system, or an indicator of inspection result.

15. The tape and reel machine vision inspection system of claim 1 wherein the processor is further configured to identify a defect selected from one or more of: an incorrect part, an incorrect lot, an incomplete component, an empty cavity, a misoriented placement, or a poor quality marking.

16. A method of performing an automated tape and reel machine vision inspection, the method comprising:
determining, by a computing device of a tape and reel machine vision inspection system, one or more templates for inspecting a plurality of components processed by a tape and reel machine in a packaging process, the tape and reel machine vision inspection system including a camera, a lens, one or more lights, a printed circuit board (PCB) interface configured to interface the tape and reel machine vision inspection system with the tape and reel machine, and a frame grabber;
obtaining, by the computing device, at least one image of a component that is processed by the tape and reel machine using the camera and the lens;
comparing, by the computing device, the image of the component that is processed by the tape and reel machine with the one or more templates to determine whether the image of the component and the one or more templates match within a specified threshold; and
determining, by the computing device, whether the component passes or fails inspection.

17. The method of claim 16 further comprising adjusting one or more of: a light intensity, contrast control, gamma control, or focus of the lens.

18. The method of claim 16 further comprising generating a template from an image of a component obtained by the camera and the lens, wherein the template includes one or more regions of interest.

19. The method of claim 16 further comprising detecting an empty cavity in a roll.

20. The method of claim 16 further comprising identifying a defect selected from one or more of: an incorrect part, an incorrect lot, an incomplete component, an empty cavity, a misoriented placement, or a poor quality marking.
